(19) United States
(12) Patent Application Publication
(10) Pub. No.: US 2010/0198498 A1
(43) Pub. Date: Aug. 5, 2010

(54) USE OF A MOBILE NAVIGATION DEVICE AS A PARKING TIME ASSISTANT

(75) Inventor: Ralph Jansen, Marktbreit (DE)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Navigon AG, Hamburg (DE)

(21) Appl. No.: 12/666,501

(22) PCT Filed: Jun. 4, 2008
(86) PCT No.: PCT/DE08/00921

§ 371 Date: Dec. 23, 2009

(30) Foreign Application Priority Data
Jun. 28, 2007 (DE) 10 2007 030 259.4

(51) Int. Cl. G01C 21/36

(52) U.S. Cl. 701/201; 701/209

(57) ABSTRACT

The present invention relates to a method for operating a mobile navigation device, including the following process steps: a) approaching a parking space with a vehicle in which the mobile navigation device is disposed; b) identifying the current position of said vehicle as a parking space; c) automatically storing the arrival time at the parking space and/or a resulting arrival time derived from the arrival time at the parking space.

The present invention relates to a method for operating a mobile navigation device.

Mobile navigation devices are finding increasingly widespread use compared with such embodiments in which the navigation device is disposed in a motor vehicle for instance in a fixedly installed fashion. Mobile navigation devices are microcomputers on which the suitable navigation software is implemented. Besides, embodiments in which the navigation software is installed on mobile phones are likewise known.

Known navigation devices serve the purpose of providing the route guidance action, wherein a suitable travel route is calculated and displayed to the user when the start and destination data have been entered.

In addition, navigation devices into which a desired arrival time can be entered are also known. On the basis of the calculated travel route and the travel time presumably needed for covering the same, the navigation device automatically calculates a departure time at which the travel route needs to be embarked on at the latest. The calculation of the travel time until reaching the destination is thereby performed by taking into account various means of transport, in particular also when travelling by foot, by bus or by train.

Proceeding from this prior art, it is consequently an objective of the present invention to propose a new method for operating a mobile navigation device that is capable of upgrading the functionality and efficiency of the navigation device for the benefit of the user.

This objective is attained by a method according to the teaching of claim 1.

Advantageous embodiments of the present invention are the subject-matter of the subclaims.

The fundamental concept of the method according to the present invention resides in the aspect that the navigation device is utilized as a parking time assistant. The basis for utilizing the mobile navigation device as a parking time assistant is constituted by the feature that the navigation device is disposed in a vehicle, whereby said vehicle approaches a parking space. As soon as said parking space is reached by the vehicle, the current position is identified as a parking space by means of appropriate evaluation algorithms and by taking into account suitable sensor signals. As soon as the navigation device has identified the current position of the vehicle as a parking space, an automatic storing of the arrival time at the parking space and a resulting arrival time derived from the arrival time at the parking space is performed.

When the user subsequently walks away from the vehicle taking along the mobile navigation device, the arrival time at the parking space, the resulting arrival time derived from the arrival time at the parking space or any other temporal parameter that has been calculated on the basis of said two times can be displayed at any time. In this way, the user is provided with assistance that enables him to readily observe given parking time limits and prepaid parking periods respectively. In the light of the aspect that the approaching of the parking space and the identification as a parking space are performed automatically, the user is not required to note down the arrival time at the parking space already when he/she leaves the vehicle. Instead, the storing of the arrival time at the parking space and the resulting arrival time is performed automatically by means of the navigation device.

The basis of the inventive method is constituted by the automatic identification of the current position as a parking space by means of the mobile navigation device. Said identification of the current position as a parking space can be performed with the aid of various evaluation strategies by taking into account various sensor data. According to a first alternative, the current position can be verified in the road network database. If said position is furnished with a parking space reference in the road network database, i.e. with an additional piece of information identifying said position as a parking space, said piece of information can be evaluated to mean that the current position must constitute a parking space.

Alternatively or additionally thereto, the route guidance operation can also be evaluated for identifying the parking space. When the destination of the route guidance operation has been reached, this aspect can be evaluated as an indication specifying that a parking space has been reached. According to a third alternative, the fact of whether the mobile navigation device is still positioned in its fixture in the vehicle is respectively monitored. If the navigation device is removed from its fixture, this aspect may, in turn, be evaluated as an indication specifying that a parking space has been reached. The same applies in such an instance in which the navigation device has been disconnected from the power supply of the vehicle or when the stand-by mode of the mobile navigation device has been activated. Besides, it is also possible that corresponding data relating to the parking space are recorded upon entering of the same. In the event that the user for instance enters a maximum parking period that has for instance been paid by him/her beforehand, this aspect, in turn, represents a strong indication of the fact that the parking space has been reached. The various strategies for identifying the current position as a parking space can thereby as a matter of fact also be combined individually or as a whole and/or be prioritized. By means of realizing a prioritization, it is possible to achieve that the various decision criteria for identifying the current position as a parking space can be taken into account to a higher or lesser degree. In the event that the current position has for instance been identified as a parking space on the basis of the aspect that the mobile navigation device has been removed from its fixture in the vehicle and the corresponding time has been stored as arrival time at the parking space or as resulting arrival time derived from the arrival time at the is parking space, it is inexpedient to overwrite said arrival time at the parking space or the resulting arrival time, if the stand-by mode of the mobile navigation device is activated. In the very same way, a plurality of prioritizations can be specified between the various decision criteria and can be stored in suitable decision tables.

The automatic storing of the arrival time at the parking space and the derived resulting arrival time, respectively, form the basis of the inventive method. In addition thereto, the current position of the navigation device or the previously available current position of the navigation device can also be stored as a parking position. In this way, the parking procedure is documented in a largely complete manner by means of the arrival time and the positioning thereof. Thus, by using the inventive method, the user can not only be provided with assistance in observing parking times but also in locating the parking position. When entering a region that is not covered by the GPS network, such as a multi-story car park, the last position determined with the aid of GPS can be stored as a parking position.

Navigation devices of the generic type can be employed for indicating to the user a travel route to a certain destination on the basis of a start position. In the event that the parking position has also been stored when the parking space has been reached, the navigation device is thusly capable of providing the driver with assistance in locating said parking space at a later point of time. In the event that the mobile navigation device is removed from the vehicle and is carried by the user to another optional intermediate position, a route guidance action, in particular likewise a pedestrian route guidance action that guides the user from the intermediate position to the parking position, can be displayed to the user by means of a simple routing action. The calculation and displaying of said route guidance action can thereby also be performed particularly upon the explicit request on the part of the user.

In certain parking situations, the indication of a travel route for locating the parking space can be realized only with difficulty. For instance when parking on large trade fair premises that are devoid of a clearly defined course of the road, the travel routes can be specified only insufficiently in the conventional manner. In any such special parking space situations, it is consequently expedient that the route guidance action comprises the output of additional data with respect to the distance to the parked vehicle and/or data with respect to the direction to the parked vehicle. In this way, the user is capable of readily locating the parking position and can subsequently select an appropriate travel route.

If the vehicle has been parked in a large multi-story car park, it is frequently desirable to know the proper access road to said multi-story car park. Insofar as the various access roads to the multi-story car park are stored in the road network database, it is consequently expedient to provide the user during the route guidance action with data relating to the selection of the optimum access road, i.e. the access road with the shortest and fastest connection to the parking space position.

Moreover, the estimated duration until completion of the route guidance action from the intermediate position to the parking position can also be calculated and displayed to the user, so that said time interval can likewise be incorporated into the strategies pursued for observing a given parking time. Based on said estimated duration, warning signals can also be output in order to remind the user of the required driving time.

It is particularly advantageous if the time that has elapsed since arrival at the parking space is displayed to the user on the mobile navigation device. In this way, the user is at any time provided with an overview of the parking time that has already elapsed and is thusly capable of avoiding increased parking fees when exceeding certain parking time intervals.

Alternatively or additionally thereto, the maximum parking time can also be displayed to the user. The maximum parking time thereby results from the arrival time at the parking space and the maximum parking period. The maximum parking period can thereby be constituted by parking times paid beforehand or a parking time limit assigned to a parking space. The corresponding piece of information needs to be entered into the navigation device by the driver with the aid of the input device. On the basis of any such additional piece of information, for instance the parking time paid beforehand or a parking time limit, the navigation device subsequently counts down the remaining maximum parking time, resulting in that the user is at any time provided with an overview of the remaining parking time. In the event that for instance 13:00 h has been automatically stored as the arrival time at the parking space and when the user enters a parking time limit of 2 hours as an additional piece of information, on the basis thereof the remaining maximum parking period of initially 2 hours and the maximum parking time until 17:00 h, respectively, can be indicated.

According to another alternative, provision is made for the aspect that the user enters the desired departure time from the parking space and on the basis thereof, the navigation device displays the remaining parking time that is left until the desired departure time is reached by taking into account the time of arrival at the parking space. In the event that the user for instance enters 18:00 h as the desired departure time subsequent to the automatic storing of 12:00 h as the arrival time at the parking space, it is possible to display to the user the respectively remaining parking period of initially 6 hours in an up-to-date fashion.

In the event that the user has walked away from the vehicle, in addition to observing the maximum parking time, the duration until completion of the route from the intermediate position to the parking position has to be taken into account as well. This can be automatically monitored by the navigation device by means of monitoring the duration until completion of the route compared with the remaining parking period. As soon as the remaining parking period approaches the estimated travel time, the navigation device is capable of automatically generating a notice signal for the user and to thereby indicate to him/her that he/she is due to embark on the way back to the parking space in order to observe the maximum parking time.

The monitoring of the remaining parking period is preferably performed by means of calculating the route at regular intervals, which can also be performed in the stand-by mode of the device. The frequency of the calculation is thereby preferably configurable. In the event that a low battery charging level should be detected even though the stand-by mode has been utilized, this aspect needs to be indicated by means of a warning signal when the parking assistant function is activated.

The monitoring of the remaining parking period compared with the estimated travel time can thereby also be resumed when having already embarked on the way back to the parking space. As soon as the difference thereby, in turn, results to be <0, a warning signal can once again be indicated to the user, so that he/she is capable of reacting correspondingly, for instance by accelerating the walking pace or by selecting a faster means of transport.

In order to capture the parking space operation, in some parking situations it is insufficient to store only the parking time and the parking position. In particular when parking in large multi-story car parks, it is rather expedient to additionally store the corresponding pieces of information for specifying the parking space, in particular the number of the parking story or the parking region. In order to make this possible, corresponding storage space can be provided, wherein further parking space identification data can be stored subsequent to the entering of the same. The inventive method is based on the automatic storing of the parking time. In order to be able to properly capture said time, it is expedient to evaluate the satellite-based positional data, in particular GPS data. In this way, erroneous settings of the time measuring device can be precluded, since the satellite-based positional data are always up-to-date. The taking into account of daylight saving time/standard time and time zone differences can likewise be performed by means of an interaction between GPS and the data of the stored digital map.

The inventive method will be exemplarily specified in the following paragraphs with reference to the drawings, wherein:

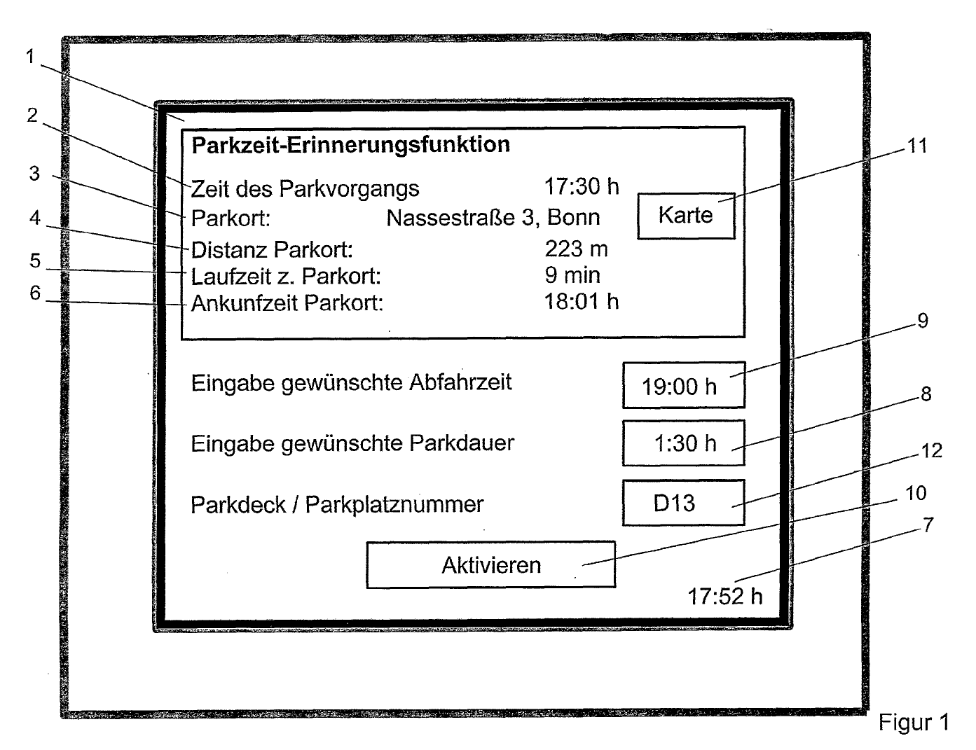

FIG. 1 illustrates the display device of a navigation device in a first process state;

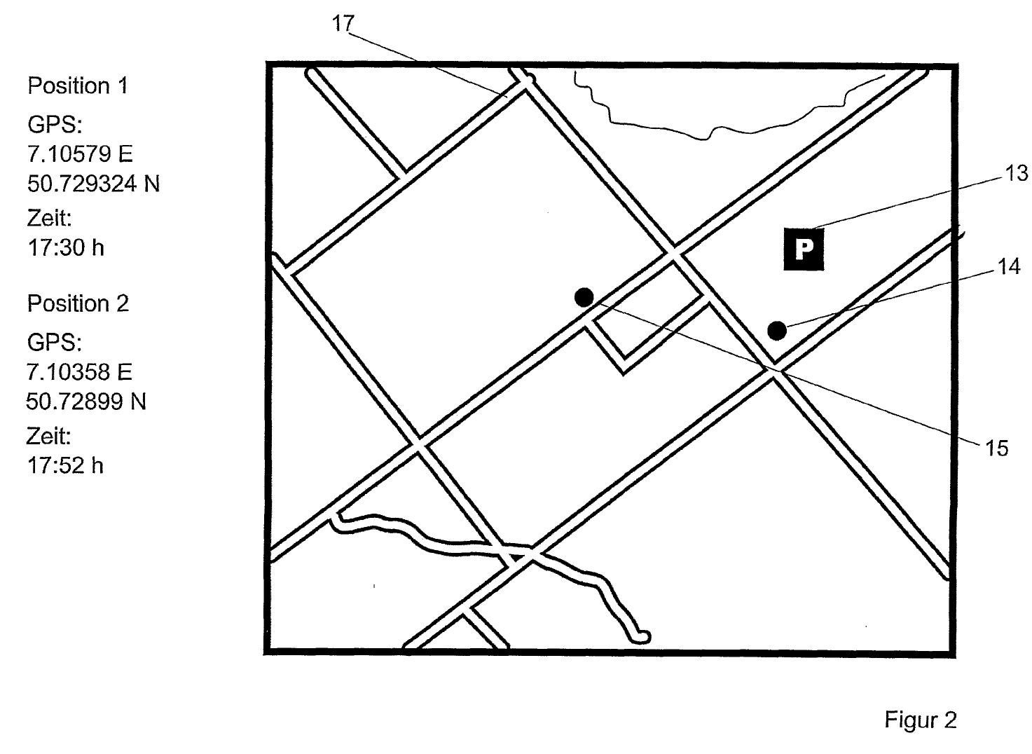

FIG. 2 illustrates the display device according to FIG. 1 in a second process state;

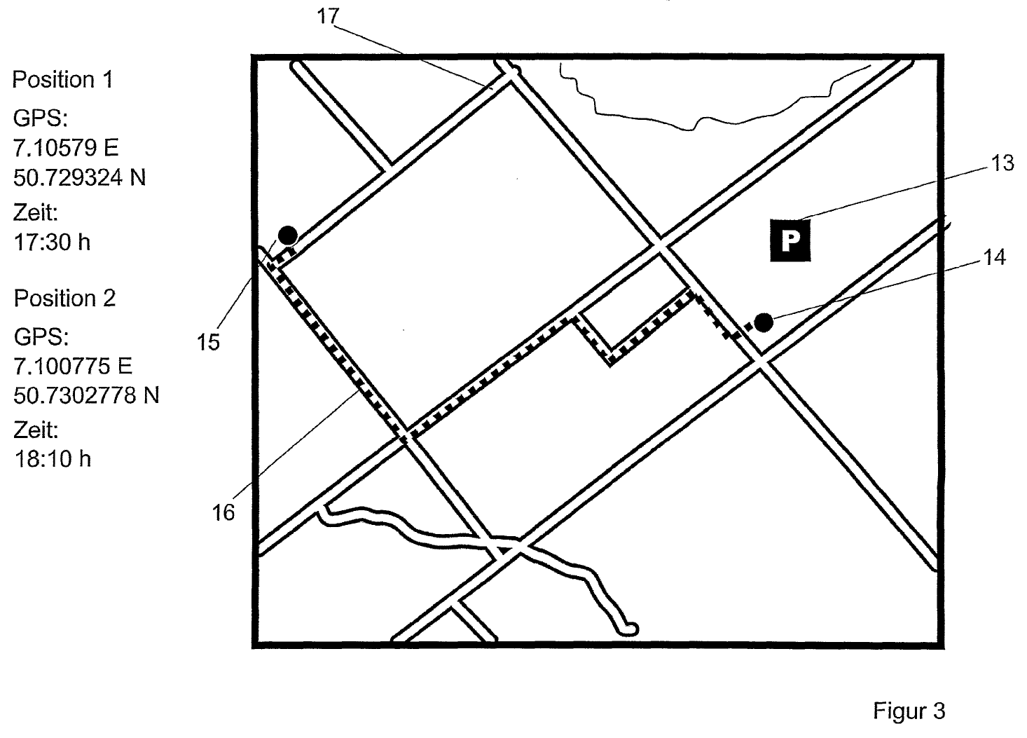

FIG. 3 illustrates the display device according to FIG. 1 in a third process state.

In order to perform the inventive method, it is assumed that the navigation device is in an activated state. Probably the navigation device has guided the user to a destination by means of a routing action and the user has consequently brought the vehicle into a parking position. With respect to the inventive method it is basically immaterial if the same is performed in a multi-story car park, in a parking area or a simple parking space at the roadside with a parking meter, a parking disk or else a ticket from a parking ticket vending machine.

Usually, in the case of paid or limited parking facilities the driver either buys a parking ticket, draws an entry card, operates a parking meter or sets a parking disk.

In all of the aforesaid instances, the exceeding of a certain parking period that is dependent on the arrival time at the parking space results in an increase in the parking fee that may exceed the budget planned to be spent by the driver. Any such instances in which the exceeding of the permitted parking time results in that a fine can be imposed for contravening traffic regulations are particularly relevant.

When the driver leaves the vehicle and carries the mobile navigation device with himself/herself, the navigation device can serve as a warning instrument and information source by using the inventive method, enabling the user to return to his/her vehicle in good time, in order to thereby prevent that the maximum parking time is exceeded. Thereby, it is the basis of the inventive method that the user is not required to execute manual operations, but the navigation device automatically stores the arrival time at the parking space. It is thereby particularly advantageous if the parking position is likewise stored automatically. By means of this measure, it is possible to display to the user a reminder signal and the expiration of the maximum parking period at a later point of time.

According to the example illustrated in FIG. 1, the user has specified that he/she wishes to be reminded of the parking time and thusly operates the navigation device in such a manner so as to activate the parking time reminder function. This measure is performed by activating a selection menu by means of operating a corresponding key or by operating a touch-screen, whereon a corresponding parking time form is illustrated (see FIG. 1).

The following pieces of information are thereby displayed on the display device:
a) time of the parking procedure (arrival time at the parking space) 2;
b) parking location (parking position) 3;
c) distance 4 to parking location;
d) walking time 5 to parking location;
e) time of arrival 6 at parking location.

In order to determine said values, the navigation device has detected one of the following events and has stored for said events the point of time and the position as a parking position.
a) identification of a parking space reference at the current position;
b) removing the navigation device from its fixture;
c) disconnecting the navigation device from the power supply;
d) activating the stand-by mode of the navigation device;
e) manually selecting a paid parking time;
f) entering a region that is not covered by the GPS network (for instance a multi-story car park).

A combination of said events can likewise be evaluated for the detection when approaching a parking space, so that all or some of said events are monitored and the current position and the time when the event occurs are stored. In case a region that is not covered by the GPS network is entered, the position prior to entering the region that is not covered by the GPS network is stored as the last position. It is also possible to realize a prioritization and temporal classification, so that for instance the manual selection of a paid parking time can in no event whatsoever be overwritten by another event. In comparison with the identification of the destination of the navigation action, however, the later or the earlier one of the two events is stored as the potentially last parking position.

It is likewise possible that several potentially ultimate parking positions are stored, so that the user can be provided with a selection. According to the example illustrated in FIG. 1, the time needed for the parking procedure, i.e. the arrival time at the parking space, is displayed. Moreover, the parking position 3 is displayed, whereby in the present case preferably the road element that is closest to the positional coordinate detected via GPS is determined and displayed. In this context, it is particularly advantageous if the street number of the parking position is interpolated and extrapolated, respectively, as well. Besides, it is also possible to display the town/city and/or the postal code as well.

In the case at hand it is advantageous to offer the displaying of a map featuring a zoom/PAN function by means of an activation surface, such as a key 11 on a touch-screen. When said key 11 is activated, a map exhibiting a marked parking position and the marked current location can be displayed. The parking position can still be more accurately stored irrespective of the displayed address in order to be capable of easily locating the vehicle on large parking areas, for instance on trade fair or stadium premises.

The distance to the parking location 4 is determined by a route calculation by means of which the distance between the current location and the parking location can be determined. In this route calculation, preferably the setting of a pedestrian routing action is taken into consideration. This setting can, where appropriate, also be configured corresponding to a personal preference on the part of the user.

Based on the distance to the parking location and a predicted travel speed, the walking time 5 needed to reach the parking location is derived. In addition, on the basis of the current time 7 and the calculated walking time 5, the estimated arrival time 6 is determined and displayed. The estimated arrival time 6 specifies until which point of time the vehicle can still be reached at its parking position by taking the present location as a starting point.

Thereby, the user is provided with the option of activating the parking time reminder function according to two alternatives:
a) by entering the desired departure time;
b) by entering the desired parking period.

The first alternative is deemed to be expedient primarily in the case where a parking ticket has been bought at a ticket vending machine that has determined a target time as a function of the parking fee that was paid. Said target time can be entered into the input field 9.

In other instances, in which the running parking time is of relevance, as in the case of a parking disk or in a multi-story car park, the same can be entered into the input field 8. In this context, it is expedient to define the desired parking period by means of a simple selection, for instance in 30-minute time intervals.

In addition, the user can also be provided with the option of recording additional pieces of information for specifying the parking location. According to the example, the parking deck number and/or the parking space number can be entered into an input field 12. It is also conceivable that further pieces of information are entered, for instance that locating the vehicle in the parking facility involves an additional expenditure of time. On the basis of said additional pieces of information, an additional time buffer can be included into the parking time monitoring process.

By means of pressing a key 10, the parking time monitoring process is activated and the resulting time is subsequently displayed in the field 8 and 9, respectively. According to the example illustrated in FIG. 1, the desired parking period has been set at 1½ hours, so that on the basis of the time needed for the parking procedure it is determined that the required departure time is due to expire at 19:00 h.

FIG. 2 illustrates the type of map that can be displayed by activating the key 11. In this map, the parking position 14 of the parked vehicle in a multi-story car park 13 and the current position of the user 15 are displayed. The mobile navigation device is thereby carried by the user and is thusly located at position 15. In the light of the aspect that the parking position and the arrival time at the parking space have been automatically stored, the user can take the decision to activate the parking time reminder function also at a later point of time, for instance when he/she has already reached his/her current position 15.

Subsequent to the activation of the parking time reminder function, the navigation device calculates, at regular intervals, the time needed for a pedestrian to walk the way between the current position 15 and the parking position 14 according to the preconfigured settings. Said time is compared with the current time and the planned time of arrival at the parking location. In order to be warned by the device in good time, it is advantageous to set several countdown levels. In this respect, a first warning can be output when 15 minutes are still left until the latest starting point is reached based on the current position 15, in order to reach the vehicle at the parking position 14 within the estimated time frame. At another 5-minute time intervals, further warning signals can be output, whereby said further warning signals can, where appropriate, be output with increasing sound intensity or in an increasingly alarming fashion.

The device is capable of displaying the result of the last route calculation as a countdown, so that the user is enabled to readily recognize by throwing just one glance at the device how much time is left until he/she needs to embark on the way back at the latest to reach the vehicle at the parking position 14.

In the light of the aspect that the warning signal is supposed to prompt the user to embark on the way back in the direction of the parking location of the vehicle, the time needed to walk from the current location to the parking location is still determined at regular intervals. Thereby, it is also possible to recognize whether the output of a warning is still necessary or not. When a corresponding warning is output, the user may subsequently for instance accelerate his/her walking speed. FIG. 3 illustrates such a situation. The user has reached a new current position 15 that is located farther away from the parking position 14. A route 16 is calculated that guides the user from his/her current position 15 to the parking position 14 and that is optimized for a pedestrian. On the basis of the distance and the current time, it is possible to calculate an to estimated arrival time for the route, by means of which the user is enabled to recognize if he/she is capable of observing the planned departure time from the vehicle parking position.

In the event that it is detected that the walking time will be significantly shortened, i.e. that the user has actually embarked on the way back to the vehicle at the parking position 14, the warning threshold can also be increased in order to prevent that another warning is output, for instance when waiting at red traffic lights.

It is advantageous if the route guidance action for pedestrians to the parking location can be automatically started by means of simple user interaction, for instance by pressing a button or by activating a push button on a touch-screen. In this context, it is possible to represent on the display in a configurable fashion the aspect of whether the vehicle will be reached in good time or how much time is still left in order to reach the destination in good time. The additional pieces of information with respect to the parking space that have been entered upon activation of the parking time reminder function can also be automatically displayed. After termination of the pedestrian route guidance action, it is advantageous if the display is automatically changed back to a mode that was activated prior to the route guidance action.

1-15. (canceled)

16. A method for operating a mobile navigation device, the device comprising:
an input device into which operating commands and/or location data can be entered,
a road network database,
a route calculation unit for calculating a planned route taking into account the location data and the road network database,
a signal receiving unit for receiving position signals,
a position determining unit for determining the current position of the navigation device,
a display device,
including the following process steps:
a) approaching a parking space with a vehicle in which the mobile navigation device is disposed;
b) identifying the current position of said vehicle as a parking space;
c) automatically storing the arrival time at the parking space and/or a resulting arrival time derived from the arrival time at the parking space.

17. The method for operating a mobile navigation device according to claim 16, wherein the location data is start data and/or destination data.

18. The method for operating a mobile navigation device according to claim 16 wherein the position signals are GPS signals.

19. The method according to claim 16, wherein the current position is identified as a parking space if:
a) the current position determined by the position determining unit is stored in the road network database with a parking space reference, and/or
b) the destination of a route guidance operation is reached, and/or
c) the mobile navigation device has been removed from its fixture in the vehicle, and/or
d) the mobile navigation device has been disconnected from the power supply of the vehicle, and/or
e) the stand-by mode of the mobile navigation device has been activated and/or
f) the input of data relating to the parking space, particularly the input of a maximum parking period, has been recorded.

20. The method according to claim 16, wherein the current position of the navigation device or the previously available current position of the navigation device is stored as a parking position when the arrival time at the parking space and/or the resulting arrival time is/are stored.

21. The method according to claim 16, wherein the mobile navigation device is removed from the vehicle and is carried by the user to another intermediate position, whereby a route guidance action, particularly a pedestrian route guidance action from the intermediate position to the parking position, is calculated and displayed to the user.

22. The method according to claim 21, wherein the route guidance action comprises the output of data relating to the distance to the parked vehicle and/or data relating to the direction to the parked vehicle.

23. The method according to claim 21, wherein the vehicle is parked in a parking space of a parking facility, particularly in a multi-story car park, with multiple access roads, whereby during the route guidance action, the user is provided with data relating to the selection of the optimum access road.

24. The method according to claim 22, wherein the vehicle is parked in a parking space of a parking facility, particularly in a multi-story car park, with multiple access roads, whereby during the route guidance action, the user is provided with data relating to the selection of the optimum access road.

25. The method according to claim 21, wherein the estimated duration until completion of the route guidance action from the intermediate position to the parking position is calculated and displayed.

26. The method according to claim 16, wherein the time that has elapsed since arrival at the parking space is displayed to the user.

27. The method according to claim 16, wherein a maximum parking period that was paid beforehand or that corresponds to a parking time limit assigned to the parking space is entered and the remaining parking time that is left until the maximum parking period derived from the arrival time at the parking space and the maximum parking period is reached is displayed to the user.

28. The method according to claim 16, wherein a desired departure time from the parking space is entered and the remaining parking time that is left until the desired departure time is reached is displayed to the user.

29. The method according to claim 28, wherein a notice signal is output as soon as the remaining parking time approaches the estimated duration until completion of the route guidance action from the intermediate position to the parking position.

30. The method according to claim 29, wherein the notice signal is output as soon as the remaining time is shorter than or equal to the estimated duration until completion of the route guidance action from the intermediate position to the parking position

31. The method according to claim 29, wherein the notice signals change as a function of the difference between the remaining parking time and the estimated duration until completion of the route guidance action from the intermediate position to the parking position.

32. The method according to claim 31, wherein the notice signals change subject to an incremental increase in sound intensity.

33. The method according to claim 16, wherein when the route guidance action from the intermediate position to the parking position is performed, it is monitored whether the estimated duration until completion of the remaining route exceeds the remaining parking time, whereby a notice signal is output as a function of the comparison result.

34. The method according to claim 16, wherein further data assigned to the approached parking space are entered and stored.

35. The method according to claim 34, wherein the further data assigned is parking space identification data.

36. The method according to claim 16, wherein the time measurement is performed by evaluation of satellite-based positional data.

37. The method according to claim 36, wherein the satellite-based positional data is GPS data.
